(19) United States
(12) Patent Application Publication
(10) Pub. No.: US 2008/0098629 A1
(43) Pub. Date: May 1, 2008

(54) SEMI-LOCKING LICENSE PLATE HOLDER

(75) Inventors: Mark Alan Graham, Springboro, OH (US); Stephen Lee Osborne, Springboro, OH (US)

Correspondence Address: MATTHEW R. JENKINS, ESQ., 2310 FAR HILLS BUILDING, DAYTON, OH, 45419, US

(73) Assignee: REAL CARBON FIBER LLC D.B.A ZERO 261 DESIGN GROUP, Dayton, OH (US)

(21) Appl. No.: 11/923,150

(22) Filed: Oct. 24, 2007

Related U.S. Application Data
(60) Provisional application No. 60/854,360, filed on Oct. 26, 2006.

(51) Int. Cl. B60R 13/10; G09F 7/06

(52) U.S. Cl. 40/201; 40/209; 70/258

(57) ABSTRACT

A semi-locking license plate holder for an automobile including a rear frame, a frame cover and optionally a transparent plate. The rear frame has at least one fastener attach point for insertion of at least one fastener such that the fastener head abuts the rear frame securing it to the automobile. The frame further includes an assembly mechanism having at least one pin arm. The pin arm has at least one pin for attachment to the frame cover. The frame cover has at least one pin hole designed to align with at least one pin on the pin arm such that the pins may be inserted into the pin hole or holes. The frame cover has at least one fastener head cover for covering at least one and preferably all of the fastener heads such that the fastener heads cannot be used to remove the license plate without first removing the frame cover.

### CROSS-REFERENCE TO RELATED APPLICATIONS

This patent application is related to provisional patent application Ser. No. 60/854,360, filed Oct. 26, 2006, to which Applicants claim the benefit of the earlier filing date. That application is incorporated herein by reference and made a part hereof.

This patent application is also related to design patent application entitled “SEMI-LOCKING LICENSE PLATE HOLDER,” Ser. No. ______, filed concurrently herewith, and which is hereby incorporated by reference

### BACKGROUND OF THE INVENTION

1. Field of the Invention

The invention relates to a license plate holder for securing a license plate to a vehicle.

2. Description of the Related Art

There are many examples of license plate holders in the prior art. Those with locking features such as U.S. Pat. No. 6,481,126 dated Nov. 19, 2002 are quite elaborate with a plurality of parts and moving parts. U.S. Pat. No. 4,903,422 dated Feb. 27, 1990 has fewer parts, provided you are willing to drill through the vehicle body 21 to enclose the bolt and protect it from those intent upon mischief. In either case the proposed license plate holder is likely too complicated for the average automobile owner.

Non-locking license plate holders such as that disclosed in U.S. Pat. No. 4,730,404 dated Mar. 15, 1988 are simpler but not aesthetically pleasing to some, nor do they require any tool or key for the removal of the license plate.

What is needed, therefore, is an improved license plate holder.

### SUMMARY OF THE INVENTION

The present invention includes a semi-locking license plate holder for an automobile. The license plate holder including a rear frame, a frame cover and optionally a transparent plate. The rear frame preferably has at least one fastener attachment point for insertion of at least one fastener such that the fastener head abuts the license plate and rear frame securing it to the automobile. The frame further includes an attachment mechanism having at least one pin arm. The pin arm has at least one pin for attachment to the frame cover. The frame cover has at least one pin hole designed to align with at least one pin on the pin arm such that the pins may be inserted into the pin hole or holes. The frame cover has at least one fastener head cover for covering at least one and preferably all of the fastener heads such that the fastener heads cannot be used to remove the license plate without first removing the frame cover.

The license plate holder preferably includes a transparent plate disposed between the rear frame and the frame cover. The fastener may extend through the transparent plate or optionally the plate may be secured in place by the frame cover using adhesive or adhesive backed tape. The transparent plate may have at least one fastener head relief region to allow the transparent plate to fit over the fastener heads. Alternatively, this region of the transparent plate may be removed to allow access to the fastener heads after the frame cover is removed. Alternatively, the depth of the frame may be increased to provide additional clearance for fasteners without providing a relief in the transparent cover.

The license plate holder may further include a removable, separate disassembly tool having at least one pin displacer. The disassembly tool may be designed to fit around a portion of the frame cover and push at least one pin out of the pin hole to facilitate disassembly of the license plate holder. The disassembly tool may also be used to assist with the assembly of the license plate holder.

It is an object of the invention to provide a semi-secure license plate holder that can attach in a standard fashion to an automobile yet cover the fastener heads to improve the aesthetics and decrease the ease of license plate theft.

In one aspect, one embodiment of the invention provides an automobile semi-locking license plate holder comprising at least one fastener for external attachment of the license plate holder to an automobile, at least one fastener having a fastener head, a rear frame having at least one fastener attach point for insertion of the at least one fastener such that the fastener head abuts the rear frame, an assembly mechanism having at least one pin arm having at least one pin for attachment to and a frame cover having at least one pin hole designed to align with the at least one pin such that the at least one pin may be inserted into the at least one pin hole, the frame cover further having at least one fastener head cover for covering a plurality of fastener heads.

In another aspect, another embodiment of the invention provides a license plate holder kit including at least one fastener for external attachment of the license plate holder, the at least one fastener having a fastener head, a rear frame having at least one fastener attach points for insertion of the at least one fastener such that the fastener head abuts the rear frame, a frame cover having at least one pin hole designed to align with the at least one pin such that the at least one pin may be inserted into the at least one pin hole, the frame cover further having at least one fastener head cover for covering a plurality of the fastener heads, an assembly mechanism having at least one pin arm having at least one pin for attaching the rear frame and the frame cover together and at least one disassembly tool having at least one pin displacer designed to push the at least one pin out of the pin hole and separate or assemble the license plate holder.

In still another aspect, an embodiment of the invention provides a frame for framing a license plate comprising a generally rectangular frame body, the generally rectangular frame body comprising a plurality of screw covers for covering a plurality of screws, respectively, after the frame body is mounted over the license plate.

In yet another aspect, an embodiment of the invention provides a license plate holder for a vehicle comprising a first member having a plurality of apertures for receiving a plurality of fasteners, respectively, for fastening the first frame member to the vehicle, and a second member for detachably mounting to the first member, the second member comprising at least one screw cover for covering the plurality of screws.

In still another aspect, one embodiment of the invention provides a frame for framing a license plate, the frame comprising a frame member having a cover face that becomes generally opposed to a front surface of the license plate when the cover is mounted on the vehicle, the cover face having a plurality of screw head covers that cover a plurality of screws so that at least one of visibility or accessibility of the screws is reduced.

These and other objects and advantages of the invention will be apparent from the following description, the accompanying drawings and the appended claims.

### BRIEF DESCRIPTION OF THE DRAWINGS

FIG. 1 is an exploded view of a license plate assembly in accordance with one embodiment of the invention;

FIG. 2A and 2B are views showing a tool used with the embodiment shown in FIG. 1;

FIG. 3A is a view of a first member illustrating resilient detents;

FIGS. 3B and 3C are exploded views of portions of the first member showing further details of the resilient arms or detents; and

FIG. 4 is a perspective view of the second member and illustrating the use of the tool with the second member.

### DETAILED DESCRIPTION OF THE PREFERRED EMBODIMENTS

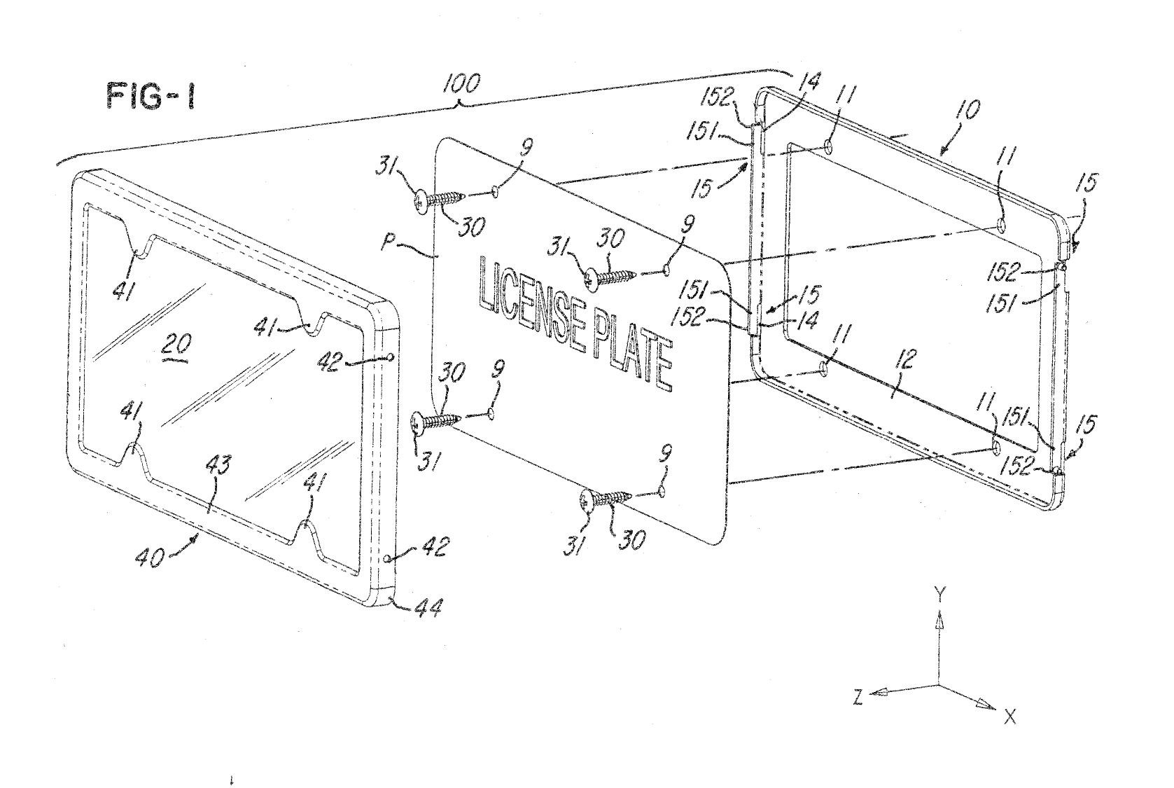

FIG. 1 shows a semi-locking license plate holder 100 having a rear frame 10, a license plate or frame cover 40 and an optional transparent plate 20.

The rear frame 10 includes at least one and preferably at least two fastener attachment points or apertures 11 that extend through a rear frame face 12 and an auto frame face (not shown). These attach points are used in conjunction with any fastener known in the art to attach the rear frame 10 to an automobile with the rear frame face 12 facing away from the automobile.

The rear frame 10 preferably includes a rear frame side edge 18. The rear frame side edge 18 preferably extends generally perpendicular from the rear frame face 12 and preferably extends away from the automobile. The rear frame side edge 18 may extend all the way around the rear frame 10 as shown in FIG. 1 or alternatively extend around only a portion of the rear frame 10.

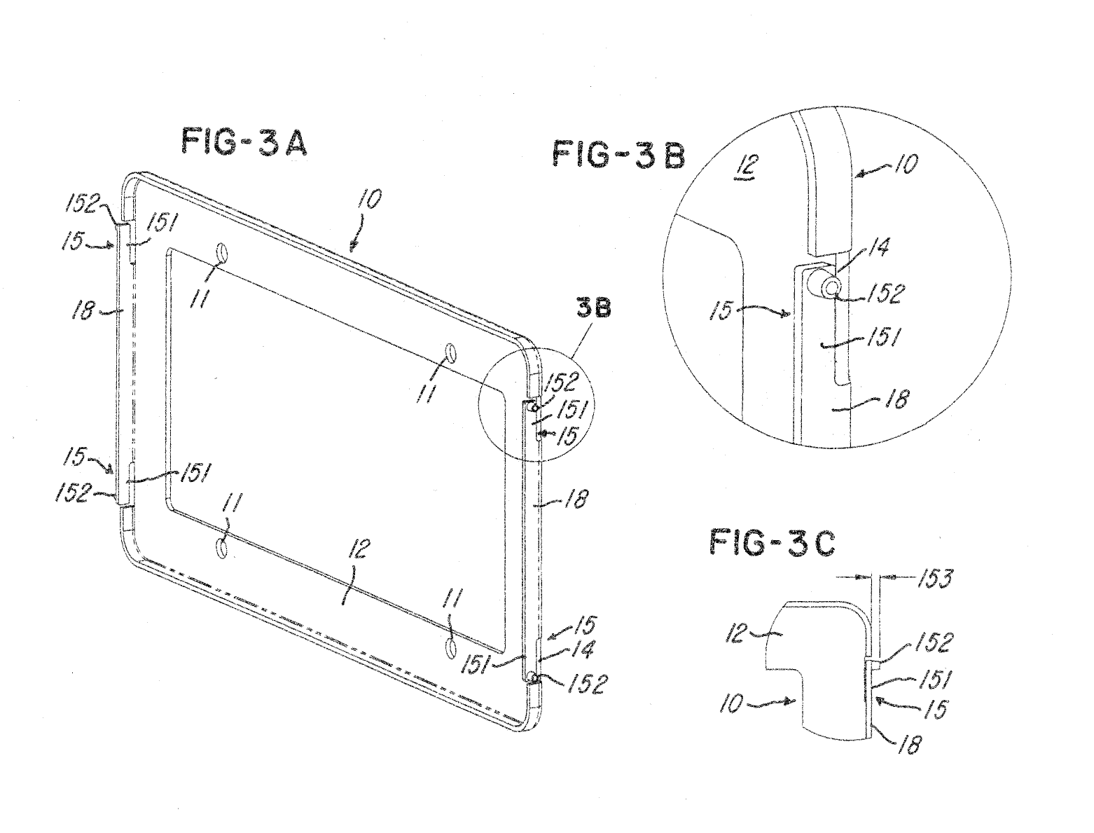

The rear frame 10 further includes at least one assembly mechanism 15, preferably located on the rear frame side edge 18. The at least one assembly mechanism 15 preferably includes a pin arm 151 and a pin 152 (FIGS. 3A-3C). The pin arm 151 may be formed by cutting, casting or injection molding, the pin arm 151 is designed to be an integral part of the rear frame 10 and is preferably made from the same material to reduce costs. When fabricated, a relief gap 14 as shown in FIGS. 1 and 3B may be preferred. If the pin arm 151 is formed by cutting a portion of the rear frame 10, there may preferably not be a relief gap. FIG. 1 shows the pin arms 151 extending in opposite y directions. It is anticipated that the pin arms 151 could alternatively extend in the same Y direction. Further, the pin arm 151 may be formed to extend in the ±Z direction of FIG. 1. The pin arm 151 is preferably resilient such that when pushed in the X direction of FIG. 1, it tends to return to approximately its original location (along with the pin 152) in less than three seconds. More preferably the pin arm 151 tends to return to approximately its original location (along with the pin 152) in less than one second.

The pin 152 may be any shape. The pin 152 is preferably a cylindrical protuberance but for example it may be square, triangular or oval as well. The pin 152 is preferably about 4 millimeters in diameter. The pin 152 may more preferably be less than 4 millimeters in diameter. The pin 152 may protrude from the pin arm 151 any distance. The pin 152 preferably protrudes about 4 millimeters from the pin arm 151. The pin 152 preferably has a lift distance 153 (FIG. 3C). This lift distance 153 corresponds to how far out in the X direction the pin 152 extends from the auto frame face (not shown).

FIG. 1 shows a typical fastener 30 received in the apertures 9 in license plate P and apertures 11 for securing the rear frame 10 to the auto frame face (not shown). The fastener 30 optionally having a fastener head 31. The fastener 30 may be any means known in the art. FIG. 1 depicts a common screw configuration for the fastener 30. The fastener 30 could also be for example a combination of nuts and bolts, compression snaps or any other means.

The optional transparent plate 20 is made from any transparent material known in the art. The material may alternatively be semi-transparent or preferably directionally transparent such that the transparency may be obscured such as with an Anti Photo-Radar Plate Cover. The fastener 30 may extend through the transparent plate 20 or optionally the transparent plate 20 may be secured in place by the frame cover 40. If the fastener 30 does not extend through the transparent plate 20, then the transparent plate 20 may have at least one fastener head relief region to allow the transparent plate 20 to fit over the fastener heads 31. Alternatively, this region of the transparent plate 20 may be removed to allow access to the fastener heads 31 after the frame cover 40 is removed.

The frame cover 40 in FIG. 1 is preferably a single formed piece. The frame cover 40 may be made from any material known in the art. The frame cover 40 is preferably made from carbon fiber and fiber glass composite. The frame cover 40 preferably has a frame cover face 43 facing generally parallel to the rear frame face 12 and also away from the vehicle. The frame cover 40 preferably has a frame cover side edge 44.

The frame cover side edge 44 preferably extends generally perpendicular from the rear frame face and preferably extends towards the automobile it is to be attached to. The frame cover side edge 44 may extend all the way around the frame cover 40 as shown in FIG. 1 or alternatively only a portion of the frame cover 40. The frame cover side edge 44 preferably includes at least one pin hole 42 for receiving the at least one pin 152. The frame cover side edge 44 is designed to overlap the rear frame side edge 18 (FIG. 3A) such that the pin 152 may be inserted or biased into the pin hole 42, securing the frame cover 40 in place with the auto license plate being between the rear frame 10 and the frame cover 40, preferably between the rear frame 10 and the optional transparent plate 20.

The frame cover 40 preferably has at least one fastener head cover 41 to cover the otherwise exposed fastener heads 31. These fastener head covers 41 are designed to prevent at least one of the viewing of or access to the fastener heads 31 while the frame cover 40 is attached. These fastener head covers 41 are further designed to prevent access to and use of the fastener heads 31 to remove the fasteners 30 while the frame cover 40 is attached.

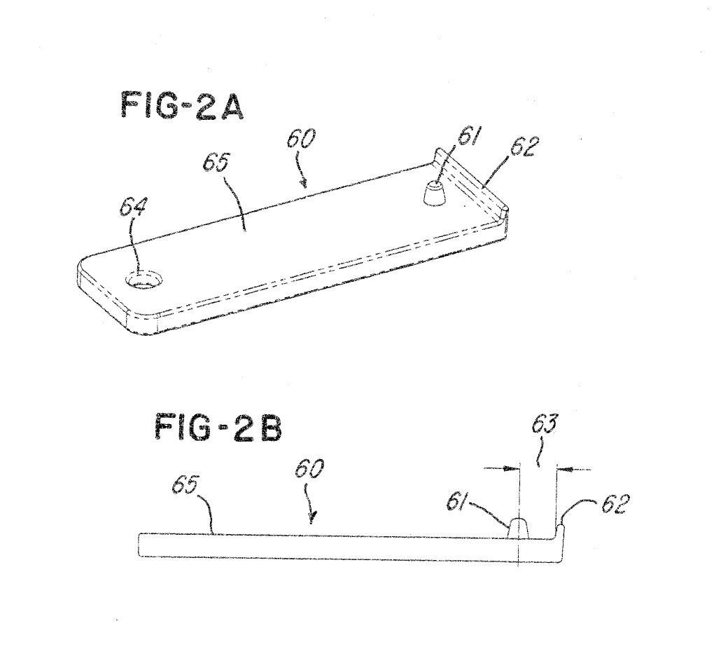

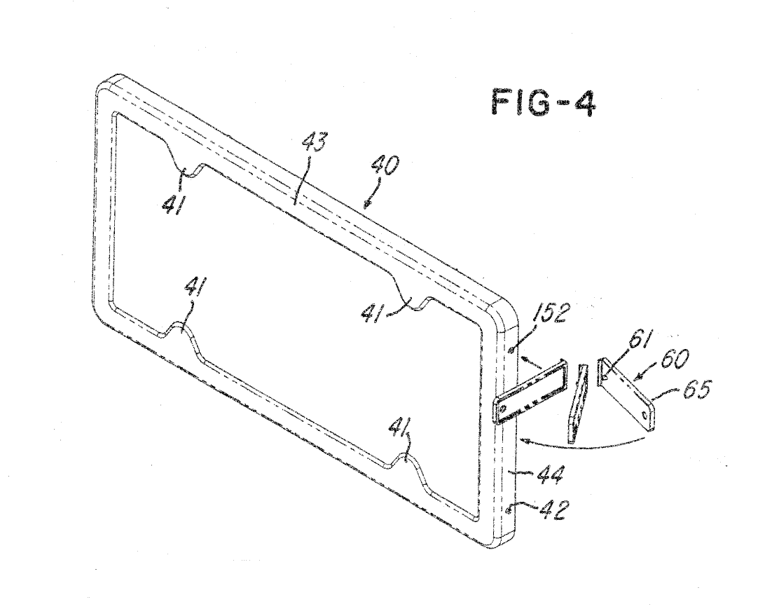

FIGS. 2A-2B and 4 show a disassembly tool 60. The disassembly tool 60 may be designed to fit around a portion of the frame cover 40 and push at least one pin arm 151 out of the pin hole 42 to facilitate disassembly of the license plate holder. The disassembly tool 60 may also be used to assist with the assembly of the license plate holder. The disassembly tool 60 may include a handle or head 65, an alignment lip 62, a pin displacer 61 on the head 65 at an alignment distance 63. The alignment distance 63 on the disassembly tool 60 generally corresponds to or is slightly larger than the lift distance 153 on the rear frame 10 (FIG. 1). This allows the pin displacer 61 to easily align with the pin 152 (FIG. 1) and displace it for the removal and/or assembly of the semi-locking license plate holder 100. This creates a semi-locking mechanism that must be disengaged or destroyed before the fastener heads 31 are exposed so the fastener 30 can be removed. The disassembly tool 60 may optionally include a key ring hole 64 for attaching the disassembly tool 60 to a key ring.

While this system is not designed to be impenetrable, it is designed to both slow the process of removing a license plate P and hide the exact means, such as the fastener(s) 30, of attachment to the automobile. The fastener head 31 may be hex head, a standard screw driver, a star design, square design, or any configuration known in the art. Thus, a license plate thief, with so many plates to chose from will simply move on to someone else where he knows he has the proper tool to remove the license plate. The present invention has the added benefit of providing a more aesthetically pleasing appearance by covering otherwise unsightly exposed auto fasteners.

While the form of apparatuses herein described constitute preferred embodiments of this invention, it is to be understood that the invention is not limited to these precise forms of apparatuses, and that changes may be made therein without departing from the scope of the invention which is defined in the appended claims.

What is claimed is:

1. An automobile semi-locking license plate holder comprising:
at least one fastener for external attachment of a license plate holder to an automobile,
said at least one fastener having a fastener head;
a rear frame having at least one fastener attach point for insertion of the at least one fastener such that the fastener head abuts the rear frame;
an assembly mechanism having at least one pin arm having at least one pin for attachment to; and
a frame cover having at least one pin hole designed to align with the at least one pin such that the at least one pin may be inserted into the at least one pin hole, the frame cover further having at least one fastener head cover for covering a plurality of fastener heads.

2. The license plate holder of claim 1 further comprising a transparent plate disposed between the rear frame and the frame cover and having at least one fastener head relief region.

3. The license plate holder of claim 1 further comprising a removable disassembly tool having at least one pin displacer designed to push the at least one pin out of the at least one pin hole and separate or assemble the license plate holder.

4. The license plate holder of claim 1 further comprising at least one relief gap between at least a portion of the rear frame and at least a portion of the at least one pin arm.

5. The license plate holder of claim 1 wherein the at least one pin arm is resilient.

6. The license plate holder of claim 1 wherein the rear frame is a single integral piece and the frame cover is a single integral piece.

7. A license plate holder kit including:
at least one fastener for external attachment of a license plate holder,
the at least one fastener having a fastener head;
a rear frame having at least one fastener attach points for insertion of the at least one fastener such that the fastener head abuts the rear frame;
a frame cover having at least one pin hole designed to align with the at least one pin such that the at least one pin may be inserted into the at least one pin hole, the frame cover further having at least one fastener head cover for covering a plurality of the fastener heads;
an assembly mechanism having at least one pin arm having at least one pin for attaching said rear frame and said frame cover together; and
at least one disassembly tool having at least one pin displacer designed to push the at least one pin out of the at least one pin hole and separate or assemble the license plate holder.

8. A frame for framing a license plate comprising:
a generally rectangular frame body, said generally rectangular frame body comprising a plurality of screw covers for covering a plurality of screws, respectively, after said generally rectangular frame body is mounted over the license plate.

9. The frame according to claim 8, wherein said plurality of screw covers being integral with said generally rectangular frame body.

10. The frame according to claim 8, wherein said plurality of screw covers comprise a curvature that extends from said generally rectangular frame body in order to cover the plurality of screws so that they are not visible.

11. The frame according to claim 8, wherein said generally rectangular frame body comprises a plurality of locking apertures for receiving a resilient detent in order to detachably lock said generally rectangular frame body to the vehicle.

12. A license plate holder for a vehicle comprising:
a first member having a plurality of apertures for receiving a plurality of fasteners, respectively, for fastening said first member to the vehicle; and
a second member for detachably mounting to said first member, said second member comprising at least one screw cover for covering a plurality of screws.

13. The license plate holder as recited in claim 12 wherein at least one of said first member or said second member comprises an integral lock for detachably locking said first member and said second member together.

14. The license plate holder as recited in claim 13 wherein said integral lock comprises at least one aperture on at least one of said first member or said second member and a resilient latch integrally formed in the other of said second member or said first member, said resilient latch comprising at least a portion that is received in said at least one aperture, thereby locking said first member to said second member.

15. The license plate holder as recited in claim 13 wherein said integral lock comprises a plurality apertures on at least one of said first member and a plurality of resilient latches integrally formed in said second member, said plurality of resilient latches comprising at least a portion that is received in said plurality of apertures, respectively, thereby detachably locking said first member to said second member.

16. The license plate holder as recited in claim 12 wherein said second member comprises a cover face for framing at least a portion of a license plate.

17. The license plate holder as recited in claim 13 wherein said second member comprises a plurality of screw covers that become situated in opposed relationship to said plurality of screws after said second member is detachably mounted to said first member, thereby making said plurality of screws either less visible or less accessible.

18. The license plate holder as recited in claim 17 wherein said plurality of screw covers prevents access to said plurality of screws.

19. The license plate holder as recited in claim 15 wherein said plurality of resilient latches are released from said plurality of apertures with a tool having a projection that generally compliments the shape of each of said plurality of apertures.

20. A frame for framing a license plate, said frame comprising:
a frame member having a cover face that becomes generally opposed to a front surface of the license plate when the cover is mounted on the vehicle;
said cover face having a plurality of screw head covers that cover a plurality of screws so that at least one of visibility or accessibility of said plurality of screws is reduced.
